(19) United States
(12) Patent Application Publication
(10) Pub. No.: US 2011/0195010 A1
(43) Pub. Date: Aug. 11, 2011

(54) Method of forming InP quantum dot and InP quantum dot formed by the same

(75) Inventors: Jae il Kim, Gyunggi-do (KR); Seung Mi Lee, Gyunggi-do (KR); Mi Yang Kim, Gyunggi-do (KR)

(73) Assignee: SAMSUNG ELECTRO-MECHANICS CO., LTD., Gyunggi-do (KR)

(21) Appl. No.: 12/807,344

(22) Filed: Sep. 1, 2010

(30) Foreign Application Priority Data
Feb. 9, 2010 (KR) 10-2010-0012110

(51) Int. Cl. C01B 25/00; B82Y 20/00

(52) U.S. Cl. 423/299; 977/774

(57) ABSTRACT

Disclosed herein is a method of forming a spherical InP quantum dot, including: providing a compound containing indium (In); dissolving the compound in alcohol to form a solution; and introducing a compound containing phosphorus (P) into the solution. The method is advantageous because a spherical InP quantum dot can be formed, the method is environment-friendly because alcohol is used as a solvent, because InP quantum dots can be produced in large quantities because the InP quantum dots can be formed while putting all reactants into a reactor and slowly heating the reactants, and because the desired InP quantum dots can be easily recovered by decreasing the temperature of a reactor or by performing centrifugal separation at low speed.

### CROSS REFERENCE TO RELATED APPLICATION

This application claims the benefit of Korean Patent Application No. 10-2010-0012110, filed Feb. 9, 2010, entitled “Method for preparing InP quantum dot and its product”, which is hereby incorporated by reference in its entirety into this application.

### BACKGROUND OF THE INVENTION

1. Technical Field

The present invention relates to a method of forming a quantum dot, and a quantum dot formed by the method.

2. Description of the Related Art

Generally, pyrolysis has been used not only to form a quantum dot but also to synthesize InP.

When InP is prepared using pyrolysis, a surfactant, an indium (In) source, a phosphorus (P) source and the like are heat-treated at high temperature and then pyrolyzed to form InP nanoparticles.

Currently, 1-octadecene (ODE) is used as a solvent generally used to synthesize an InP quantum dot using pyrolysis. It is well known that an InP quantum dot was made using ODE. Further, materials used as a solvent in the process of synthesizing InP are limited.

First, tri-n-octylphosphine oxide (TOPO) was used as a solvent for synthesizing InP, and, subsequently, ODE has been used as the solvent. It was found that InP having equal or excellent properties was formed when ODE was used compared to when TOPO was used.

To date, research into InP structures having electro-optical properties depending on size and shape has been made. Among the InP structures, an InP dot is the most well known. Thereafter, methods of obtaining an InP rod, an InP wire and the like have been developed.

In this case, methods of adjusting the amount and concentration of ligands used to stabilize the surface of InP are frequently used.

In conclusion, conventionally, only TOPO and ODE have been used as a solvent for synthesizing InP.

Further, since InP is formed only in the shape of a dot, a rod, or a wire, research into InP having new shapes is continuous and ongoing.

### SUMMARY OF THE INVENTION

Accordingly, the present invention has been made to solve the above-mentioned problems, and the present invention provides a method of forming a new type of InP quantum dot.

Further, the present invention provides a new type of InP quantum dot formed using the method.

An aspect of the present invention provides a method of forming a spherical InP quantum dot, including: providing a compound containing indium (In); dissolving the compound in alcohol to form a solution; and introducing a compound containing phosphorus (P) into the solution.

In the method, the alcohol may be octanol.

Further, the compound containing indium (In) may include at least one selected from among indium acetate and indium chloride.

Further, the compound containing phosphorus (P) may be tris(trimethylsilyl)phosphine.

Further, the compound containing phosphorus (P) may be introduced at a temperature of 160˜190° C.

Further, the method according may further include: growing the InP.

Further, the growing of the InP may be performed at a temperature of 180˜220° C.

Further, the growing of the InP may be performed for 25˜35 minutes.

Another aspect of the present invention provides a spherical InP quantum dot formed using the method.

The InP quantum dot may absorb visible light.

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The patent or application file contains at least one drawing executed in color. Copies of this patent or patent publication with color drawing(s) will be provided by the U.S. Patent and Trademark Office upon request and payment of the necessary fee.

The above and other objects, features and advantages of the present invention will be more clearly understood from the following detailed description taken in conjunction with the accompanying drawings, in which:

FIG. 1 is a schematic view showing the mechanism of a method of forming an InP quantum dot according to the present invention;

FIG. 2 shows transmission electron microscope (TEM) photographs of an InP quantum dot formed by the method;

FIG. 3 shows energy dispersive spectroscopic (EDS) data of a product prepared by the method;

FIG. 4 is a graph showing X-ray diffraction (XRD) results of InP prepared by the method; and

FIG. 5 is a graph showing an absorbance spectrum of InP particles depending on growth time.

### DESCRIPTION OF THE PREFERRED EMBODIMENTS

The objects, features and advantages of the present invention will be more clearly understood from the following detailed description and preferred embodiments taken in conjunction with the accompanying drawings. Throughout the accompanying drawings, the same reference numerals are used to designate the same or similar components, and redundant descriptions thereof are omitted. Further, in the description of the present invention, when it is determined that the detailed description of the related art would obscure the gist of the present invention, the description thereof will be omitted.

Hereinafter, preferred embodiments of the present invention will be described in detail with reference to the accompanying drawings.

A method of forming a spherical InP quantum dot according to the present invention includes: providing a compound containing indium (In); dissolving the compound in alcohol to form a solution; and introducing a compound containing phosphorus (P) into the solution.

Here, octanol or a long alkyl chained alcohol may be used as the alcohol.

The method can be environment-friendly because alcohol is used as a solvent. Further, the method is suitable for producing InP quantum dots in large quantities because alcohol is easy to treat and thus a large amount of alcohol can be treated at once.

Further, the compound containing indium (In) may include at least one selected from indium acetate and indium chloride, and the compound containing phosphorus (P) may be tris(trimethylsilyl)phosphine.

Further, the compound containing phosphorus (P) may be introduced at a temperature of 160˜190° C.

Further, the method may further include: growing the InP. The growing of the InP may be performed at a temperature of 180˜220° C. for 25˜35 minutes.

The InP quantum dot formed by the method has a spherical shape.

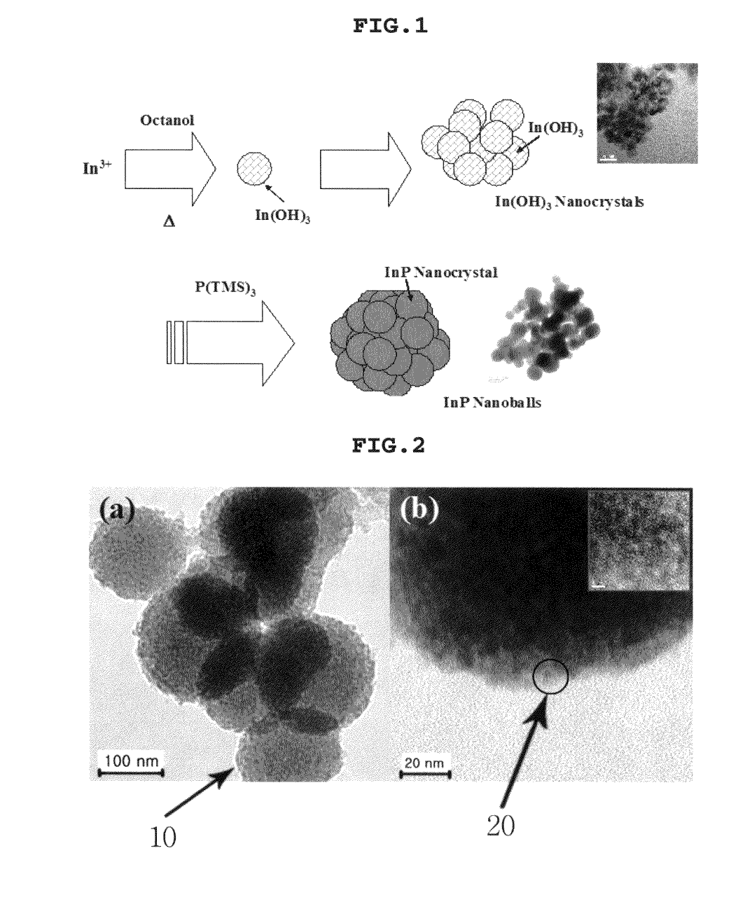

FIG. 1 shows a schematic mechanism of the method of forming an InP quantum dot to according to the present invention.

In³⁺ ions react with octanol to form In(OH)₃ molecules, and the In(OH)₃ molecules conglomerate together. Subsequently, when P(TMS)₃ is added to the conglomerated In(OH)₃ molecules, the P(TMS)₃ reacts with the conglomerated In(OH)₃ molecules to form InP.

That is, In³⁺ ions are formed from the compound containing indium, and the In³⁺ ions react with octanol to form In(OH)₃ molecules. Subsequently, when P(TMS)₃ is added to the In(OH)₃ molecules, the P(TMS)₃ reacts with the In(OH)₃ molecules to form InP.

As described above, in the method of forming an InP quantum dot according to the present invention, it is possible to form the InP quantum dots while putting all reactants into a reactor and then slowly heating the reactor, so that the production scale of the InP quantum dots can be enlarged, thereby producing the InP quantum dots in large quantities.

Further, the spherical InP quantum dots can absorb light over the wide range of visible light even though they hardly emit any light due to the conglomeration thereof. Therefore, owing to this property, the spherical InP quantum dots can be used in solar cells.

Hereinafter, an example of the present invention will be described.

Alcohol was used as a solvent and a reactant. Octanol was used as the alcohol.

First, 300 mg of InAc₃ as a compound containing indium, 1.5 mL of oleic acid (OA), and 25 ml of octanol as an intermediate reactant were provided.

Subsequently, 300 mg of InAc₃ and 1.5 mL of oleic acid (OA) were added to octanol.

Subsequently, the octanol including the InAc₃ was slowly heated, and then P(TMS)₃, which is a compound containing phosphorus (P), was introduced at a temperature of 180° C.

Thereafter, the octanol including InAc₃ was reacted with the P(TMS)₃ at a temperature of about 200° C. for about 30 minutes.

FIG. 2 shows transmission electron microscope (TEM) photographs of the InP to quantum dot formed using the example of the present invention.

It can be seen from the TEM photographs that spherical InP particles 10 are formed. Further, it can be seen from the right TEM photograph that small InP quantum dots 20 conglomerate to form a large spherical cluster.

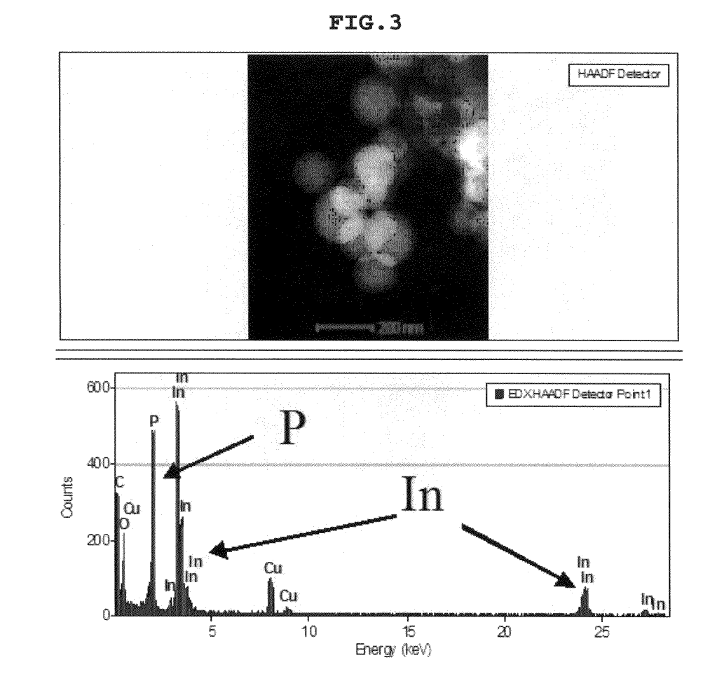

FIG. 3 shows energy dispersive spectroscopic (EDS) data of the product prepared by the example of the present invention. It can be seen from FIG. 3 that the product clearly and distinctly shows the peaks corresponding to P and In, and thus P and In are present in the product.

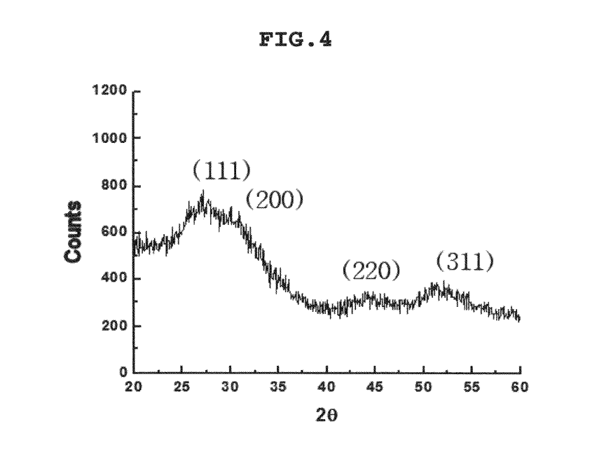

FIG. 4 shows X-ray diffraction (XRD) results of InP prepared by the example of the present invention. It can be seen from FIG. 4 that the prepared InP exhibits the same crystallinity as cubic InP.

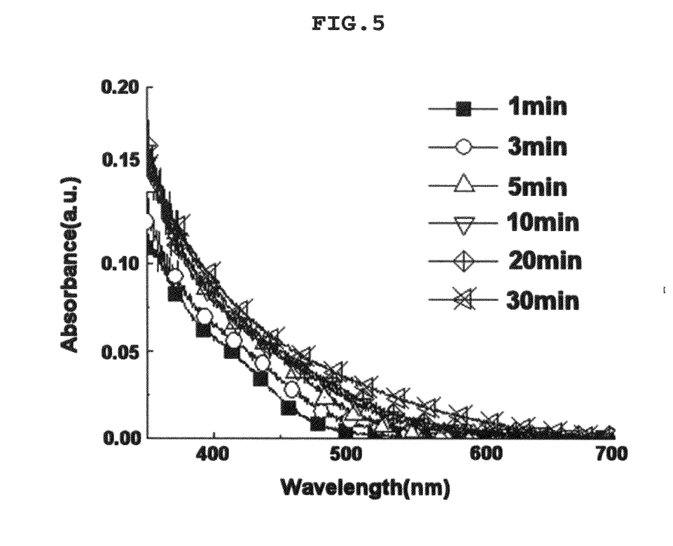

FIG. 5 shows an absorbance spectrum of InP particles depending on growth time. Referring to FIG. 5, it can be seen that the size of the InP particles increases depending on reaction time, and thus the position of absorption band slowly enlarges toward a long wavelength region. Further, it can be clearly seen from the absorbance spectrum that InP particles grown for 30 minutes can absorb light over the entire range of visible light.

For this reason, the InP quantum dot formed by the method of the present invention can be usefully used in solar cells, etc.

Furthermore, the InP quantum dot formed by the method of the present invention maintained its original shape even when it was sonicated.

As described above, the method of forming an InP quantum dot according to the present invention is advantageous in that a spherical InP quantum dot can be formed and in that the method is environment-friendly because alcohol is used as a solvent.

Further, the method of the present invention is advantageous in that InP quantum dots can be produced in large quantities because the InP quantum dots can be formed while putting all reactants into a reactor and slowly heating the reactants.

Further, the method of the present invention is advantageous in that desired InP quantum dots can be easily recovered by decreasing the temperature of a reactor or by centrifugally separating them at low speed.

Moreover, the InP quantum dots formed by the method of the present invention can absorb light over the entire range of visible light even though they hardly emit any light due to the conglomeration of particles. Therefore, the InP quantum dots can be used in solar cells, etc.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of forming a spherical InP quantum dot, comprising:
providing a compound containing indium (In);
dissolving the compound in alcohol to form a solution; and
introducing a compound containing phosphorus (P) into the solution.

2. The method according to claim 1, wherein the alcohol is octanol.

3. The method according to claim 1, wherein the compound containing indium (In) includes at least one selected from among indium acetate and indium chloride.

4. The method according to claim 1, wherein the compound containing phosphorus (P) is tris(trimethylsilyl)phosphine.

5. The method according to claim 1, wherein the compound containing phosphorus (P) is introduced at a temperature of 160˜190° C. C.

6. The method according to claim 1, further comprising: growing the InP.

7. The method according to claim 6, wherein the growing of the InP is performed at a temperature of 180˜220° C.

8. The method according to claim 6, wherein the growing of the InP is performed for 25˜35 minutes.

9. A spherical InP quantum dot formed using the method of claim 1.

10. The InP quantum dot according to claim 9, wherein the InP quantum dot absorbs visible light.
